(19) United States
(12) Patent Application Publication
(10) Pub. No.: US 2024/0089460 A1
(43) Pub. Date: Mar. 14, 2024

(54) SCENE-CHANGE DETECTION AT SERVER FOR TRIGGERING CLIENT-SIDE TEMPORAL FRAME BUFFER RESET

(71) Applicant: ATI TECHNOLOGIES ULC, MARKHAM (CA)

(72) Inventor: Pavel Siniavine, Richmond Hill (CA)

(21) Appl. No.: 17/943,625

(22) Filed: Sep. 13, 2022

(51) Int. Cl. H04N 19/142; H04N 19/172; H04N 19/184; H04N 19/423; H04N 19/70; H04N 19/87

(52) U.S. Cl. CPC H04N 19/142; H04N 19/172; H04N 19/184; H04N 19/423; H04N 19/70; H04N 19/87

(57) ABSTRACT

A processing system includes a server to render and encode a video bitstream for transmission to a client device. The server detects scene changes between consecutive frames of the video bitstream and generates an indication of the scene change for transmission to the client device. The client device detects the indication of the scene change and resets a temporal frame buffer storing data associated with frames of the video bitstream in response to detecting the indication of the scene change.

### BACKGROUND

To prepare video for streaming, storage, or additional processing, a hardware accelerator (e.g., video encoder) outputs an encoded video bitstream for each video frame at a server. The encoded bitstream is typically prepared for network transmission to a client device (also referred to herein as a client). In order to create an immersive environment for the user, video streaming applications typically require high resolution and high frame rates. Standard video codecs like H.264 and High Efficiency Video Coding (HEVC) are commonly used to encode the video frames rendered as part of video applications. As resolutions and refresh rates of displays increase, the latency required for rendering, encoding, transmitting, decoding, and preparing frames for display becomes a major limiting factor.

An example of a video streaming application is cloud gaming, also referred to as gaming on demand, gaming-as-a-service, and game streaming, in which a server executes and renders frames for a video game and streams the frames to a client device. In some situations, the client device performs spatial and/or temporal post-processing on video frames received from the server.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a video processing system that includes a server to generate scene change metadata for a video stream and a video client to clear a frame from a frame buffer based on the scene change metadata in accordance with some embodiments.

FIG. 2 is a block diagram of a server generating scene change metadata for transmission to a client in accordance with some embodiments.

FIG. 3 is a flow diagram of a method of flushing a temporal frame buffer at a client in response to receiving the scene change metadata in accordance with some embodiments.

FIG. 4 is a flow diagram of a method of associating the scene change metadata with the scene change in accordance with some embodiments.

### DETAILED DESCRIPTION

A video stream encoded and transmitted from a server is received, decoded, post-processed, and displayed at a client. Post-processing performed at the client includes operations such as processing for screen space reflections, adjusting depth of field, adjusting chromatic aberrations, adjusting color balance, tone mapping, vignetting, and temporal anti-aliasing. Post-processing that is based on temporal changes between frames of a video stream is performed by comparing a video frame saved at a temporal buffer at the client to an immediately subsequent frame received by the client. In case of a scene change, in which all or nearly all pixels are different between consecutive video frames, temporal post-processing cannot be performed, as there is insufficient correlation between consecutive frames. In the event of a scene change, the client device resets the temporal buffer to store the next frame in the sequence.

Typically, scene change detection is performed at the client. However, scene change detection is a compute-intensive procedure, which can tax the capabilities of a client device and negatively impact the client device's processing bandwidth. If the client device has relatively low processing capability, scene change detection performed at the client device for temporal post-processing for applications such as cloud gaming can introduce latency to the processing of the video stream such that the user experience is negatively impacted.

To facilitate more efficient detection of scene changes, embodiments described herein shift scene detection to the server. The server, which has relatively higher processing capabilities compared to the client device, detects scene changes between frames of a video stream and generates an indication of the scene change, such as scene change metadata, for inclusion with the video stream. The server transmits the scene change metadata along with the video stream across a network to the client device. The client device receives the video stream and scene change metadata and detects that the scene change metadata is associated with a frame of the video stream. In response to detecting the scene change metadata, the client device resets a temporal frame buffer storing data associated with a previous frame and stores a subsequent frame at the temporal frame buffer.

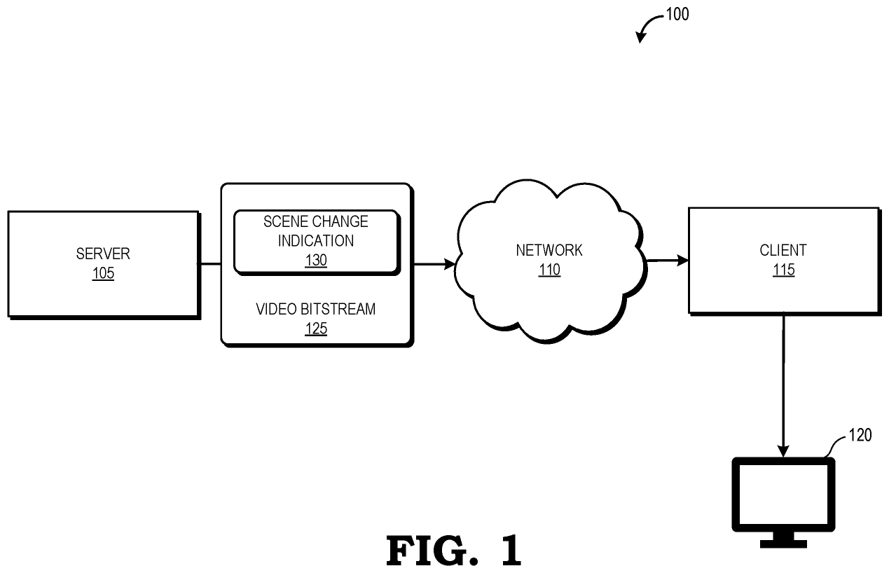

FIG. 1 illustrates a schematic diagram of an example video processing system 100 that includes a server 105 to generate scene change metadata based on detection of scene changes between frames of a video stream and a client 115 to clear a previous frame from a temporal frame buffer based on the scene change metadata, according to some embodiments.

The server 105 encodes rendered images into a video bitstream which is sent over a network 110 for display at a display 120. In other embodiments, the system 100 includes multiple clients connected to the server 105 via the network 110, with the multiple clients receiving the same bitstream or different bitstreams generated by the server 105. The system 100 also includes more than one server 105 for generating multiple bitstreams for multiple clients in some embodiments. In one embodiment, the system 100 is configured to implement real-time rendering and encoding of game content as part of a cloud gaming application. Latency, quality, bitrate, power, and performance challenges typically arise while delivering such a workload in real-time. In other embodiments, the system 100 is configured to execute other types of applications.

In one embodiment, the server 105 is configured to render video or image frames, encode the frames into a bitstream, and then convey the encoded bitstream to the client 115 via the network 110. The client 115 is configured to decode the encoded bitstream and generate video frames or images to drive the display 120 or to a display compositor. In one embodiment, the server 105 includes a game engine for rendering images to be displayed to a user. As used herein, the term “game engine” is defined as a real-time rendering application for rendering images. A game engine can include various shaders (e.g., vertex shader, geometry shader) for rendering images. The game engine is utilized in some cases to generate rendered images to be immediately displayed on a display connected to the server 105. However, some applications run using a client-server model where the rendered content is displayed at a remote location. For these applications, the rendered images are encoded by a video encoder into a video bitstream 125. The video bitstream 125 is then transmitted over the network 110 to the client 115 to be viewed on the display 120. In various embodiments, the video bitstream 125 is conveyed to the network 110 via a network interface (not shown) according to any of a variety of suitable communication protocols (e.g., TCP/IP, etc.).

The network 110 is representative of any type of network or combination of networks, including wireless connection, direct local area network (LAN), metropolitan area network (MAN), wide area network (WAN), an Intranet, the Internet, a cable network, a packet-switched network, a fiber-optic network, a router, storage area network, or other type of network. Examples of LANs include Ethernet networks, Fiber Distributed Data Interface (FDDI) networks, and token ring networks. The network 110 further includes remote direct memory access (RDMA) hardware and/or software, transmission control protocol/internet protocol (TCP/IP) hardware and/or software, router, repeaters, switches, grids, and/or other components in some embodiments.

The server 105 includes any combination of software and/or hardware for rendering video/image frames and encoding the frames into a bitstream such as video bitstream 125. In one embodiment, the server 105 includes one or more software applications executing on one or more processors of one or more servers. The server 105 also includes network communication capabilities, one or more input/output devices, and/or other components. The processor(s) of the server 105 can include any number and type (e.g., graphics processing units (GPUs), CPUs, DSPs, FPGAs, ASICs) of processors. The processor(s) can be coupled to one or more memory devices storing program instructions executable by the processor(s). Similarly, the client 115 includes any combination of software and/or hardware for decoding a bitstream and driving frames to the display 120. In one embodiment, the client 115 includes one or more software applications executing on one or more processors of one or more computing devices. The client 115 can be a computing device, game console, mobile device, streaming media player, or other type of device.

In some embodiments, the client 115 includes hardware to perform post-processing of the video bitstream 125 received from the server 105. For temporal post-processing, such as suppressing compression artifacts, scaling the image of a frame to the size of a display, frame rate conversion (FRC), video stabilization, etc., the client 115 includes a temporal frame buffer (not shown) that stores a previous frame of the video bitstream 125.

To facilitate more efficient client-side post-processing, the server 105 performs scene change detection for the video bitstream 125 by comparing a first frame (not shown) in the video bitstream 125 to a second frame (not shown) immediately following the first frame. A scene change is an instantaneous change or regional change. The terms instantaneous change, regional change, or scene change can be used interchangeably and correspond to a significant change in a portion of a frame or an entire frame with respect to the immediately prior frame. The server 105 detects scene changes using any of a variety of algorithms, including built-in hardware encode scene detection which already is performed at the encoder of the server 105, the results of which are reused as described herein. If the server 105 determines that at least a threshold amount of pixels (by number or percentage) of the first frame does not match the pixels of the second frame, the server 105 identifies a scene change between the first frame and the second frame. In response to identifying the scene change, the server 105 generates an indication 130 of the scene change for transmission to the client 115 via the network. In some embodiments, the indication 130 of the scene change is a flag or at least one scene change bit. In some embodiments, the indication 130 of the scene change is included as metadata associated with one or both of the first frame and the second frame.

The client 115 receives the video bitstream 125 and parses the video bitstream 125 to determine if the video bitstream 125 includes the indication 130 of the scene change. If the video bitstream 125 includes the indication 130 of the scene change, the client 115 resets the temporal buffer (not shown) in preparation for post-processing of the video bitstream 125. Performing scene change detection at the server 105 rather than at the client 115 saves compute capacity at the client 115 and facilitates running of temporal algorithms at the client 115.

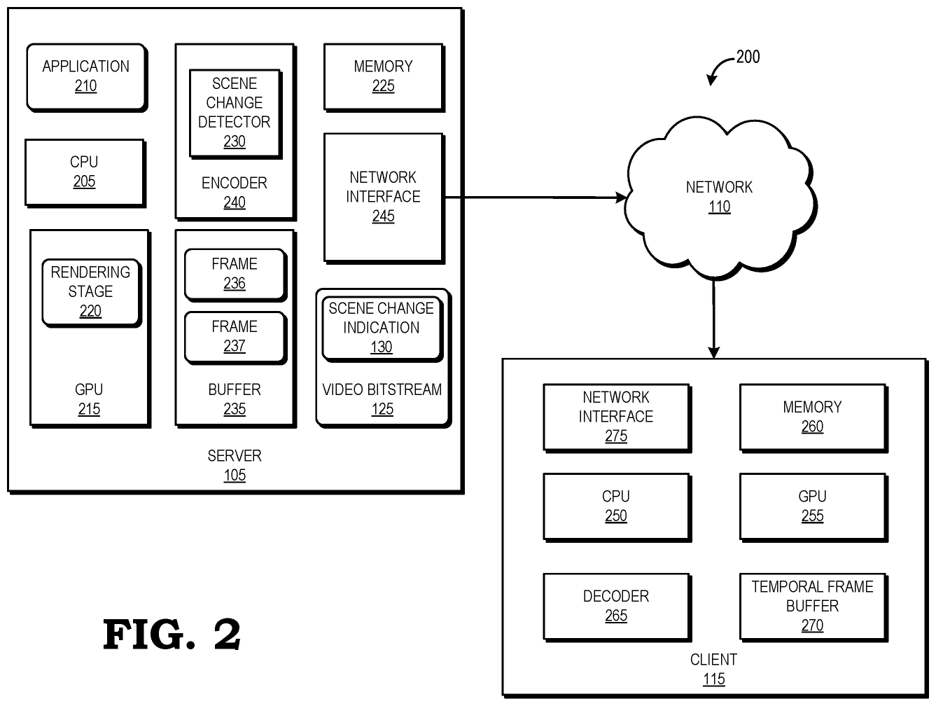

FIG. 2 is a block diagram of a processing system 200 in which a server such as the server 105 of FIG. 1 generates scene change metadata for transmission to a client device such as the client device 115 in accordance with some embodiments. The server 105 includes hardware and software to execute an application 210. In some embodiments, the application 210 is a video game application such as a cloud gaming application configured to convey and/or receive video of gameplay. In other embodiments, the application 210 is a gaming spectatorship application configured to view video of gameplay. In some embodiments, the server 105 is part of a cloud computing architecture.

In the depicted example, the hardware of the server 105 includes at least one network interface 245 to connect to the network 110, one or more processors, such as one or more GPUs 215 and one or more central processing units (CPUs) 205, and one or more computer-readable storage mediums, such as random-access memory (RAM), read-only memory (ROM), flash memory, hard disc drives, solid-state drives, optical disc drives and the like. For ease of reference, the computer-readable storage medium is referred to herein as memory 225. Further, although described in the singular, it will be appreciated that the functionality described herein with reference to memory 225 instead can be implemented across multiple storage mediums such as a cache hierarchy and buffers. Other hardware components, such as displays, input/output devices, interconnects and busses, and other well-known server components, are omitted for ease of illustration.

The one or more memories 225 of the server 105 are used to store one or more sets of executable software instructions and associated data that manipulate one or both of the GPU 215 and the CPU 205 and other components of the server 105 to perform the various functions described herein and attributed to the server 105. The sets of executable software instructions represent, for example, an operating system (OS) and various drivers (not shown), a video source application such as the video game application 210, a rendering stage 220, a post-processing stage (not shown), and a video encoder 240. As a general overview, the video game application 210 or other video source application generates a stream of draw commands and related data representative of images or other video content of a video game scene or other representation of a view or perspective of a computer-generated scene. As such, the video source application 210 typically is executed primarily by the CPU 205. The rendering stage 220 renders a stream of rendered video frames based on the stream of draw commands and related data. The post-processing stage performs one or more post-processing operations on the stream of rendered video frames, which can include one or more graphics effects operations, to generate a processed stream of rendered video frames. The encoder 240 encodes (i.e., compresses) the processed stream of rendered video frames using any of a variety of video encoding formats, such as Motion-Pictures Experts Group (MPEG) H.264 or H.265 (High-Efficiency Video Coding), or AOMedia Video 1 (AV1), to generate an encoded video bitstream 125 for transmission to the client device 115 via the network interface 245. In some embodiments, one or more of the rendering stage 220, the post-processing stage, and the encoder 240 is implemented as part of a graphics driver for the GPU 215. In some embodiments, rendering stage 220 of the GPU 215 writes a rendered video frame into a buffer 235.

To conserve compute capacity at the client device 115, the server 105 includes a scene change detector 230 to identify scene changes between consecutive frames of the rendered video stream. The scene change detector 230 is incorporated in the encoder 240 in some embodiments. In some embodiments, the scene change detector compares a first frame 236 stored at the buffer 235 to a second frame 237 immediately following the first frame 236. If the scene change detector 230 determines that the first frame 236 and the second frame 237 are insufficiently correlated, the scene change detector 230 identifies a scene change. In some embodiments, the scene change detector 230 determines insufficient correlation between frames by identifying if all or nearly all pixels are different between the first frame 236 and the second frame 237. If all or nearly all pixels are different between the first frame 236 and the second frame 237, the scene change detector 230 identifies a scene change. In response to the scene change detector 230 detecting the scene change, the scene change detector 230 generates a scene change indication 130 indicating the scene change. In some embodiments, the scene change indication 130 is a flag or at least one scene change bit, and in some embodiments, the scene change indication 130 is multiplexed with the video bitstream 125 or is included as metadata for one or both of the first frame 236 and the second frame 237. The scene change indication 130 is accompanied by a timestamp (not shown) in some embodiments.

On the client side, the client device 115 receives the encoded video bitstream 125 and any scene change indication(s) 130 and processes the encoded video bitstream 125 to generate the video bitstream 125 of rendered video frames provided for display at the display device 120. In the depicted example, the hardware of the client device 115 includes at least one network interface 275 to connect to the network 110, one or more processors, such as one or more GPUs 255 and one or more CPUs 250, a decoder 265, a temporal frame buffer 270, one or more computer-readable storage mediums (referred to herein as memory 260), and a display interface (not shown) to interface with the display device 120. Other hardware components, such as displays, input/output devices, interconnects and busses, and other well-known client device components, are omitted for ease of illustration.

The one or more memories 260 of the client device 115 store one or more sets of executable software instructions and associated data that manipulate one or both of the GPU 255 and the CPU 250 and other components of the client device 115 to perform the various functions described herein and attributed to the client device 115. The sets of executable software instructions represent, for example, an OS and various drivers (not shown). In operation, the decoder 265 receives the encoded video bitstream 125 from the server 105 via the network 110 and the network interface 275 and decodes encoded video bitstream 125 to generate a decoded stream of rendered video frames.

The decoder 265 stores frames of the decoded video bitstream 125 at the temporal frame buffer 270, where they can be referenced for post-processing at the client device 115. In at least one embodiment, the decoder 265 parses the encoded video bitstream 125 to determine if the video bitstream 125 includes a scene change indication 130. If the decoder 265 identifies a scene change indication 130 in the video bitstream 125 associated with one or both of the first frame 236 and the second frame 237, the client device 115 resets the temporal frame buffer 270. In some embodiments, resetting the temporal frame buffer 270 includes flushing or invalidating data such as the first frame 236 stored at the temporal frame buffer 270.

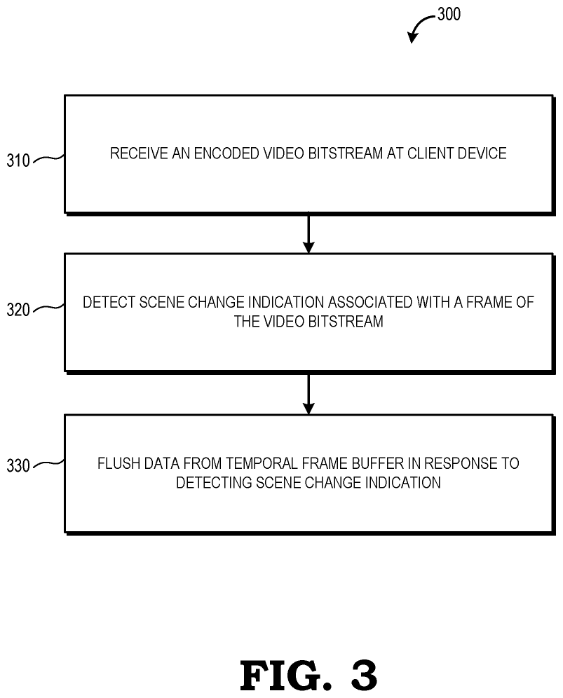

FIG. 3 illustrates an example method 300 for flushing or invalidating data stored at the temporal frame buffer 270 in response to receiving a scene change indication 130, in accordance with some embodiments. In some embodiments, the method 300 is implemented at a client device such as client device 115 of FIGS. 1 and 2. At block 310, the client device 115 receives an encoded video bitstream 125 including the scene change indication 130 indicating a scene change between the first frame 236 and the second frame 237 of the encoded video bitstream 125. In various embodiments, the scene change indication 130 is a flag, one or more scene change bits, or is incorporated as metadata associated with one or both of the first frame 236 and the second frame 237.

At block 320, the client device 115 detects the scene change indication 130 associated with a frame of the video bitstream 125. In some embodiments, the scene change indication 130 is multiplexed with the video bitstream 125, and the client device 115 includes a demultiplexer to demultiplex the scene change indication 130 from the encoded video bitstream 125.

At block 330, in response to detecting the scene change indication 130, the client device 115 flushes or invalidates data stored at the temporal frame buffer 270, such as the first frame 236.

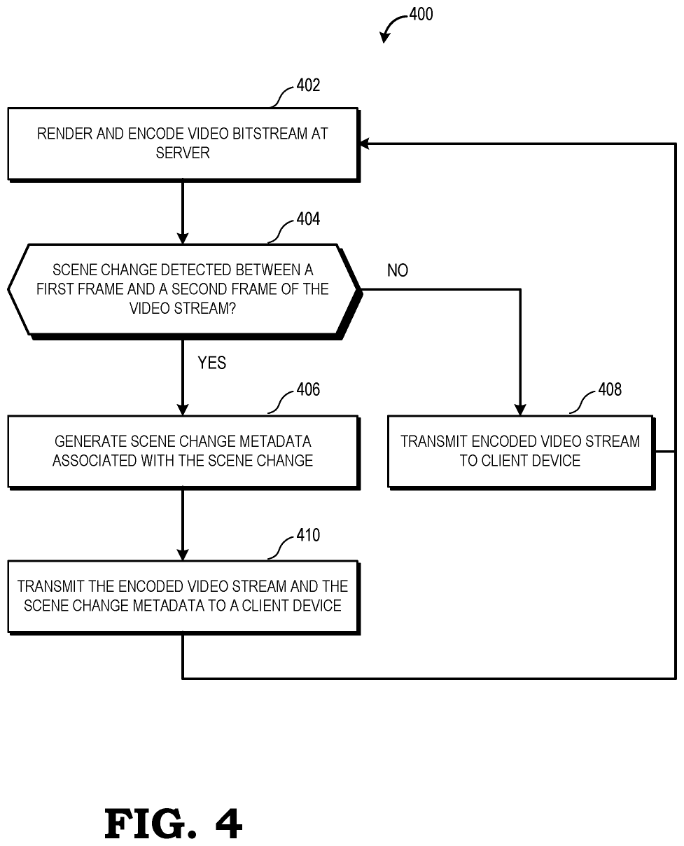

In some embodiments, the method 300 is part of a larger method that includes blocks performed by both the server 105 and the client device 115. In these embodiments, the method 300 further includes method 400 depicted in FIG. 4 that is implemented by the server 105. In some embodiments, the method 300 further includes any of the processes described above performed by the server 105 and/or the client device 115.

FIG. 4 shows an example method 400 for associating a scene change indication 130 with a scene change, in accordance with some embodiments. In some embodiments, the method 400 is implemented at a server such as the server 105 of FIGS. 1 and 2.

At block 402, the server 105 renders and encodes a video bitstream 125. At block 404, the scene change detector 230 determines whether there is a scene change between a first frame 236 and a second frame 237 of the video bitstream 125. If, at block 404, the scene change detector 230 determines that there is not a scene change between the first frame 236 and the second frame 237, the method flow continues to block 406.

At block 406, the server 105 transmits the encoded video bitstream 125 to the client device 115 via the network 110. The method flow then continues back to block 402.

If, at block 404, the scene change detector 230 detects a scene change between the first frame 236 and the second frame 237, the method flow continues to block 408. At block 408, the server 105 generates a scene change indication 130 indicating the scene change and associates the scene change indication 130 with one or both of the first frame 236 and the second frame 237. In some embodiments, the server 105 includes the scene change indication 130 in metadata associated with one or both of the first frame 236 and the second frame 237.

At block 410, the server 105 transmits the encoded video bitstream 125 and the scene change indication 130 to the client device 115 via the network 110. The method flow then continues back to block 402.

In some embodiments, the apparatus and techniques described above are implemented in a system including one or more integrated circuit (IC) devices (also referred to as integrated circuit packages or microchips), such as the processing system described above with reference to FIGS. 1-4. Electronic design automation (EDA) and computer aided design (CAD) software tools are used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device are stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium are embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device may not be required, and that one or more further activities are performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter are modified and practiced in different but equivalent manners apparent to those skilled in the art having the benefit of the teachings herein. No limitations are intended to the details of construction or design herein shown, other than as described in the claims below. It is therefore evident that the particular embodiments disclosed above are altered or modified and all such variations are considered within the scope of the disclosed subject matter. Accordingly, the protection sought herein is as set forth in the claims below.

What is claimed is:

1. A method comprising:
receiving, at a client device, a video bitstream comprising a scene change between a first frame and a second frame of the video bitstream, and an indication of the scene change;
detecting, by the client device, the indication of the scene change; and
resetting, by the client device, a temporal frame buffer in response to detecting the indication of the scene change.

2. The method according to claim 1, wherein the indication of the scene change is associated with at least one of the first frame and the second frame.

3. The method according to claim 1, wherein the indication of the scene change comprises metadata associated with at least one of the first frame and the second frame.

4. The method according to claim 1, wherein the indication of the scene change comprises at least one scene change bit.

5. The method according to claim 1, further comprising:
storing, at the temporal frame buffer, data associated with frames of the video bitstream for post-processing by the client device.

6. The method according to claim 1, wherein resetting the temporal frame buffer comprises flushing data associated with the first frame from the temporal frame buffer.

7. The method according to claim 1, wherein detecting the indication of the scene change comprises parsing, by a decoder, the video bitstream to identify the indication of the scene change.

8. A method comprising:
encoding, at a server, a video bitstream comprising a scene change between a first frame and a second frame of the video bitstream;
detecting, at the server, the scene change;
generating, at the server, an indication of the scene change; and
transmitting the encoded video bitstream and the indication to a client device.

9. The method according to claim 8, further comprising:
associating the indication with at least one of the first frame and the second frame of the encoded video bitstream.

10. The method according to claim 8, wherein the indication is included as metadata associated with at least one of the first frame and the second frame.

11. The method according to claim 8, wherein the indication comprises at least one scene change bit.

12. The method according to claim 8, further comprising:
multiplexing the indication with the video bitstream.

13. The method according to claim 8, further comprising:
transmitting a timestamp indicating the time of the scene change to the client device.

14. The method according to claim 8, further comprising:
multiplexing the encoded video bitstream and the indication prior to transmitting the encoded video bitstream and the indication to the client device.

15. A client device comprising:
a temporal frame buffer to store frames of a video bitstream received from a server for post-processing at the client device; and
a processor to detect an indication of a scene change received from the server and to reset the temporal frame buffer in response to detecting the indication.

16. The client device according to claim 15, wherein the indication is multiplexed with the video bitstream.

17. The client device according to claim 15, wherein the indication of the scene change comprises metadata associated with at least one of the first frame and the second frame.

18. The client device according to claim 15, wherein the indication of the scene change comprises at least one scene change bit.

19. The client device according to claim 15, wherein the processor is to flush data associated with the first frame from the temporal frame buffer.

20. The client device according to claim 15, further comprising:
a decoder to parse the video bitstream to identify the indication of the scene change.
